(19) United States
(12) Patent Application Publication
(10) Pub. No.: US 2018/0053213 A1
(43) Pub. Date: Feb. 22, 2018

(54) SYSTEM AND METHOD FOR COPYRIGHT CONTENT MONETIZATION

(71) Applicant: Bryan Joseph Wrzesinski, Los Angeles, CA (US)

(72) Inventor: Bryan Joseph Wrzesinski, Los Angeles, CA (US)

(21) Appl. No.: 15/677,024

(22) Filed: Aug. 15, 2017

Related U.S. Application Data
(60) Provisional application No. 62/376,717, filed on Aug. 18, 2016.

(51) Int. Cl. G06Q 30/02

(52) U.S. Cl. CPC G06Q 30/0258; G06Q 30/0277

(57) ABSTRACT

Disclosed is a system and method for copyright content monetization. The system includes a user interface that streams an advertisement, a communication system that enables an advertiser to communicate with a user, on triggering the advertisement, and enables the advertiser to trigger marketing automation workflow based on the user's behavior, an advertising system that creates marketing automation workflows and/or connects third party marketing automation system and workflows to the advertising system, and an alias messaging relay system that relays any messages received from the advertiser to the user at non-alias address of the user. The method for copyright content monetization involves streaming an advertisement, enabling the advertiser to communicate with the user on clicking the advertisement, obfuscating or masking the contact information of user and passing back the behavioral data of the user to the advertiser marketing automation system to trigger further automation actions or workflows.

### CROSS REFERENCE TO RELATED APPLICATION

This application claims the benefit of U.S. Provisional Application No. 62/376,717 filed on Aug. 18, 2016, which is incorporated by reference herein.

FIELD OF INVENTION

The present application generally relates to a system and a method for copyright content monetization by means of triggering a marketing automation workflow.

### BACKGROUND

The ability of music industry to monetize recorded music has been significantly compromised by the introduction of file sharing technology. Existing advertising tools provide users with interactive advertisements, while playing audio, video or audio-visual copyright content, in order to observe user attention in order to initiate communication between the user and the advertiser. When the users communicate with advertisers through advertisement, the contact information of the users is collected by the advertisers for marketing. In this way, the advertisers are able to capture the online activity of the users and observe the users' interest on types of advertisements.

A number of prior arts have been cited herein which offers copyright content monetization by providing advertisement to the users while playing the audio, video or audio-visual copyright content.

The prior art document U.S. 20120265615A1 discloses an advertising method which allows a user to chat with an advertiser through the advertisement without redirecting the user to third party website. Sponsored search advertisements are provided with a displayed graphic, which may visually suggest chat functionality. If the user selects or clicks on the graphic, without requiring opening of a Web page, a chat area may be provided, using which the user may be able to immediately converse with the advertiser or an agent of the advertiser regarding a subject of the sponsored search advertisement.

The prior art document U.S. 20080033818A1 discloses a method in which advertisers can track their potential consumer by capturing the online activity. The prior art talks about the communication happening between the consumer and the advertiser after clicking the advertisement.

The prior art document U.S. 20080215991A1 discloses an advertising tool for attracting user attention by providing interactive advertisement. It also discloses the establishment of a virtual meeting between the advertiser's agent and the user in the form of online chat. The tool also creates Enhanced advertiser prompt proposal (APP) (EAPP) for each APP selected for presentation, and/or Combined EAPP (CEAPP). According to the patent application, the Ads are also prioritized for presentation to the user at specific intervals of time.

Although several advertising tools or methods exists in the art as described above, these conventional tools do not provide the obfuscated details of user with advertisers and do not disclose triggering a marketing automation workflow based on user interest as will be described in the instant application.

Thus, in the light of the above mentioned prior arts and existing problems, it is evident that, there is a need for a system and method for copyright content monetization that is able to trigger a marketing automation workflow and provide obfuscated details of the user with the advertisers.

### SUMMARY

It is an objective of the present invention to provide a system and method for copyright content monetization which is efficient in terms of savings to the advertiser and increased per stream royalties to copyright holders.

It is yet another object of the present invention to increase the streaming rates of audio and video by 20-40 times pre-optimization, based on the achieved efficiency.

According to an exemplary embodiment of the present invention, a system for copyright content monetization, comprises: a processing unit; a storage unit connected to the processing unit, wherein the storage unit is adapted to store a plurality of executable modules; a user interface, executed by the processing unit, streams an advertisement at least before playing a first copyright content or subsequent to end of playing the first copyright content; a communication unit connected to the user interface, executed by the processing unit, adapted to: set a communication link between a user and an advertiser, based on an input from the user, and enable the advertiser to trigger marketing automation workflow based on at least one of input provided by the user or behavioral data of the user, wherein the behavioral data comprises a series of inputs provided by the user, in a time interval, that are stored in the storage unit; an obfuscating unit, executed by the processing unit, adapted to obfuscate or mask, from the advertiser, information of user, wherein the information of the user comprises at least one of contact information or an email ID of the user; an advertising unit, executed by the processing unit, adapted to create at least one of marketing automation workflow or connect third party marketing automation systems or workflows to the advertising system; an alias messaging relay system, adapted to relay at least one message received, from the advertiser, by the user, wherein the alias messaging relay system is communicatively coupled with the advertising system, and wherein the message is received at the non-alias address of the user; and an application programming interface (API), adapted to transmit or receive at least one message between the user and the advertiser, wherein the advertiser is adapted to link their account to a number of third party services through the API.

According to an exemplary embodiment of the present invention, a method for copyright content monetization includes: streaming an advertisement at least before playing a first copyright content or subsequent to end of playing the first copyright content; communicating with an advertiser based on an input from the user; triggering marketing automation workflow based on at least one of the input provided by the user or behavioral data of the user; obfuscating information of user from the advertiser, wherein the information of the user comprises at least one of contact information or an email ID of the user; sending obfuscated contact information to the advertiser; creating at least one of marketing automation workflow or connecting third party marketing automation systems or workflows to an advertising system; relaying at least one message received, from the advertiser, by the user, wherein the alias messaging relay system is communicatively coupled with the advertising system; and wherein the message is received at the non-alias address of the user; and transmitting or receiving at least one message between the user and the advertiser by using an application program interface (API).

According to an exemplary embodiment of the present invention, a method for copyright content monetization via a text message includes: receiving a text message with a sponsored advertisement link of the text message, clicking advertisement link or replying the text message with a text keyword by the user, receiving, by the user, a predefined marketing automation workflow of the advertiser as one or more text messages from the advertiser, obfuscating or masking the contact information of user from the advertiser, and passing back the behavioral data of user to the advertiser marketing automation system to trigger further automation actions or workflows by tracking user behavior.

The foregoing summary has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1A is a schematic block diagram disclosing a system for copyright content monetization, according to an embodiment of the present invention.

FIG. 1B is a schematic block diagram of the advertising system and associated elements according to an embodiment of present invention.

FIG. 2 is a flowchart illustrating a method for copyright content monetization, according to an embodiment of the present invention.

FIG. 3 is a flowchart illustrating a method for copyright content monetization via a text message, according to an embodiment of the present invention.

FIG. 4 is a flowchart illustrating a method for copyright content monetization performed by an advertising system, according to an embodiment of the present invention.

FIG. 5 is a flowchart illustrating a method for increasing streaming rates of copyright, according to an embodiment of the present invention.

### DETAILED DESCRIPTION OF THE INVENTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples. The invention can be better understood with the help of detailed description of the drawings and preferred embodiments of the invention.

The system and the method for copyright content monetization creates a 20-40 times increase in Return On Investment (ROI) of the advertiser before optimization. The present invention eliminates redirection of user to a landing page on clicking the advertisement as well as the subsequent attempt of the advertiser to convert the user or collect user contact information for future marketing, thus delivering an enormous increase in efficiency, which can be used towards saving cost to the advertiser as well as increasing per stream royalties to copyright holders if used during or surrounding, the performance of the audio, visual, or audio-visual copyright content.

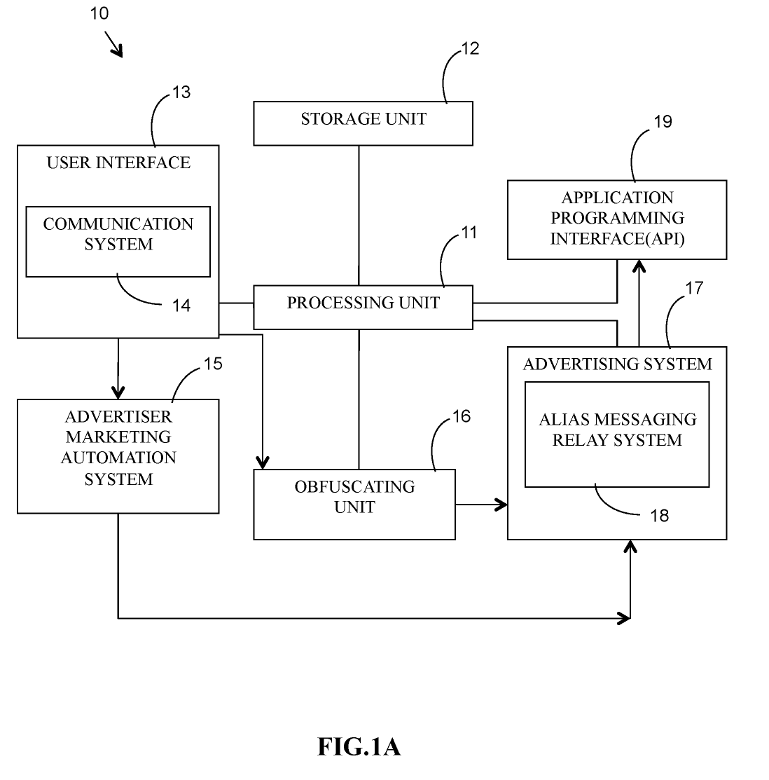

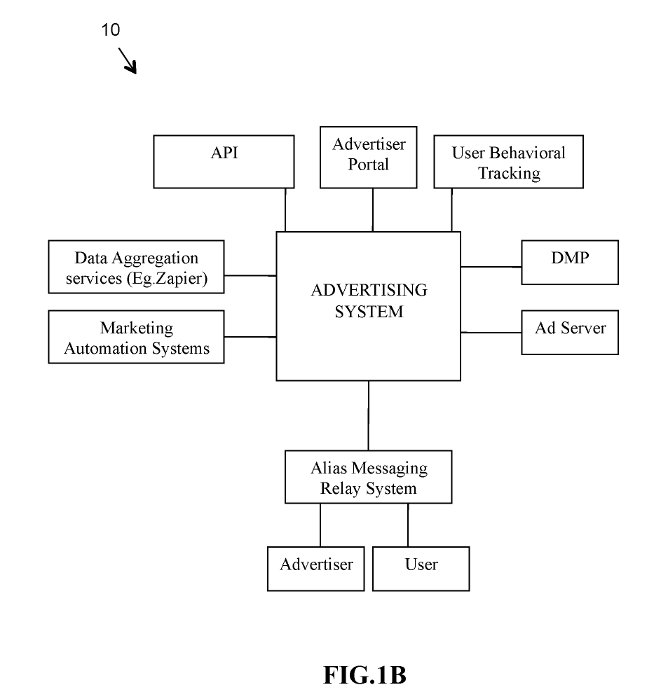

Referring to FIG. 1A discloses a block diagram of a system (10) for copyright content monetization. It comprises a processing unit (11), a storage unit (12) which is connected to the processing unit (11), wherein the storage unit (12) is configured to store a plurality of executable modules. A user interface (13) which is executed by the processing unit (11), streams an advertisement at least before playing a first copyright content or subsequent to end of playing the first copyright content, wherein the user interface includes a television, virtual reality, or interactive media playing device. The first copyright content comprises at least one of an audio data, visual data, or audio-visual data. The advertisement is streamed before the next copyright content started. A communication system (14) provided in the user interface (13) is configured to enable an advertiser to communicate with the user, on clicking the advertisement by the user, and enable the advertiser to trigger marketing automation workflow based on at least one of input provided by the user or behavioral data of the user, wherein the behavioral data comprises a series of inputs provided by the user, in a time interval, that are stored in the storage unit. The user may be able to watch the next video without being interrupted by directing to a web page on click the advertisement.

An obfuscating unit (16) is configured to obfuscate or mask the contact information of user from the advertiser. The user may also select or destroy the obfuscated or masked contact information provided to the advertiser. The contact information of user may include, but not limited to name, mobile number or email address of the user. An advertising system (17) which is executed by the processing unit (11) creates marketing automation workflows and/or connects third party marketing automation system and workflows to the advertising system (17). An alias messaging relay system (18) which is provided in the advertising system (17) is adapted to relay any messages received from the advertiser to the user at the non-alias address of the user. An application programming interface (API) (19) is adapted to send or receive messages between the user and the advertiser, wherein the advertiser may link their account to a number of third party services through the API (19).

The advertising system (17) may be provided with contact information of the user by logging the user, onto the advertising system (17), by providing email address, mobile number, messaging handle, handle on a social network, virtual reality handle, gaming handle, mailing address, IP address, retargeting cookie ID, etc. while trigging the advertisement, and by way of collecting aggregated user data sold by data companies (DMPs).

The advertising system (17) may also track non-communicative events of the user and pass back to the advertiser. These may include trackable actions of the user which are of interest to the advertiser, such as link clicks, shares, purchases, etc. The advertising system provided with contact information of the user based on logging information of the user, into the advertising system or a connected system, wherein the login information comprises at least one of the email ID, contact number, messaging handle, handle on a social network, virtual reality handle, or gaming handle.

The information of the user is provided to the advertiser, by the advertising system (17). Depending upon the communication protocol utilized, the advertising system (17) shall create an alias for the advertiser, so that the alias appropriately provided at the middle of all communications relay the messages back and forth to each party, either the advertiser or user, while maintaining the ability to obfuscate the contact information of the user.

The alias messaging relay system (18) accepts messages from the associated advertiser and relay the messages to the user at non-alias address of the user. The message shall be received first by the user on replying by the user and then the non-alias address of the user shall be replaced with the alias address of the user and then forwarded to the non-alias address of the advertiser.

Referring to FIG. 1B in conjunction with FIG. 1A, where the advertising system (17) and associated elements are shown arranged according to an embodiment of present invention. The advertising system (17) is provided in communication with the alias messaging relay system (18), advertiser marketing automation system (15), advertisement server (Ad server), advertiser portal, API (19), DMP, and data aggregation services such as Zapier, wherein the user behavior is tracked by the advertiser which is provided in connection with alias messaging relay system (18).

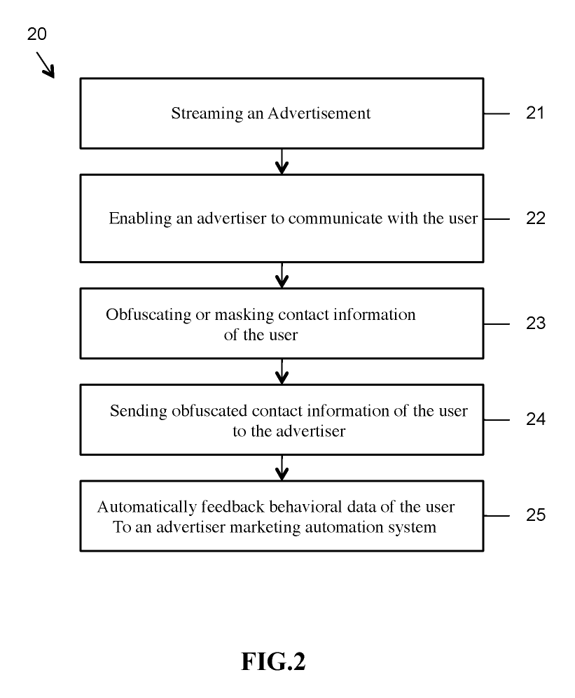

Referring to FIG. 2 shows a method (20) for copyright content monetization which involves a step (21) of streaming an advertisement before the beginning or at the end of playing an audio, visual or audio-visual copyright. Step (22) enables an advertiser to communicate with the user based on triggering the advertisement by the user. Step (23) obfuscates or masks contact information of the user from the advertiser. Step (24) sends obfuscated contact information to the advertiser. Step (25) passes back the behavioral data of user to trigger further automation actions or workflows by tracking user behavior to the advertiser marketing automation system (15).

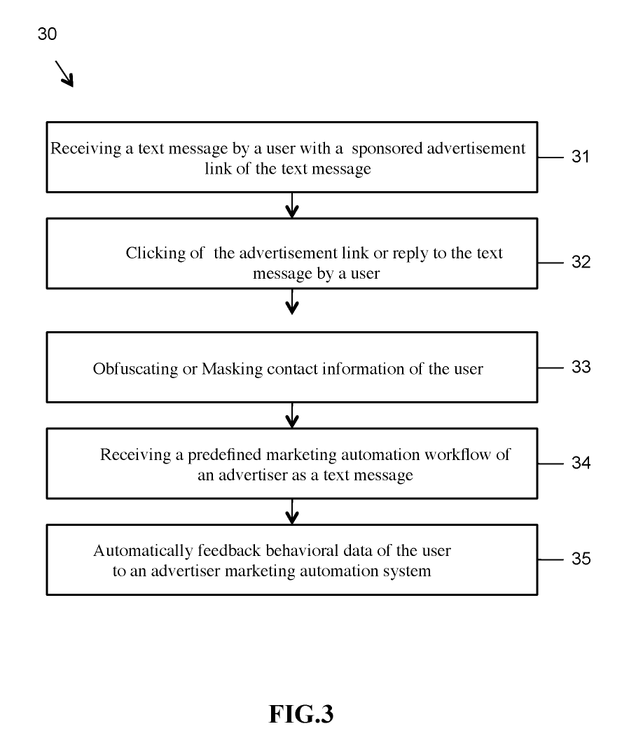

Referring to FIG. 3 shows a method (30) for copyright content monetization via a text message which involves a step (31) describes receiving a text message with a sponsored advertisement link of the text message. Step (32) describes clicking of the advertisement link or replies to the text message with a text keyword by the user. Step (33) describes obfuscating or masking the contact information of user from the advertiser. Step (34) describes reception, by the user, a predefined marketing automation workflow of the advertiser as one or more text messages from the advertiser. Step (35) describes passing back, the behavioral data of user to the advertiser marketing automation system (15) to trigger further automation actions or workflows by tracking user behavior.

In one embodiment of the invention, the user behavior may be tracked by the third party tools and systems of the advertiser, including but not limited to email based communication systems, text message backed advertising systems, virtual reality based systems, gaming system, television systems, interactive media playing systems, but not limited to these only. The user behavior includes communicative events or non-communicative events of user, wherein the events include but not limited to opening, viewing, clicking, sharing, forwarding a message, online purchasing, engaging with or completing certain activity, and clicking or sharing links.

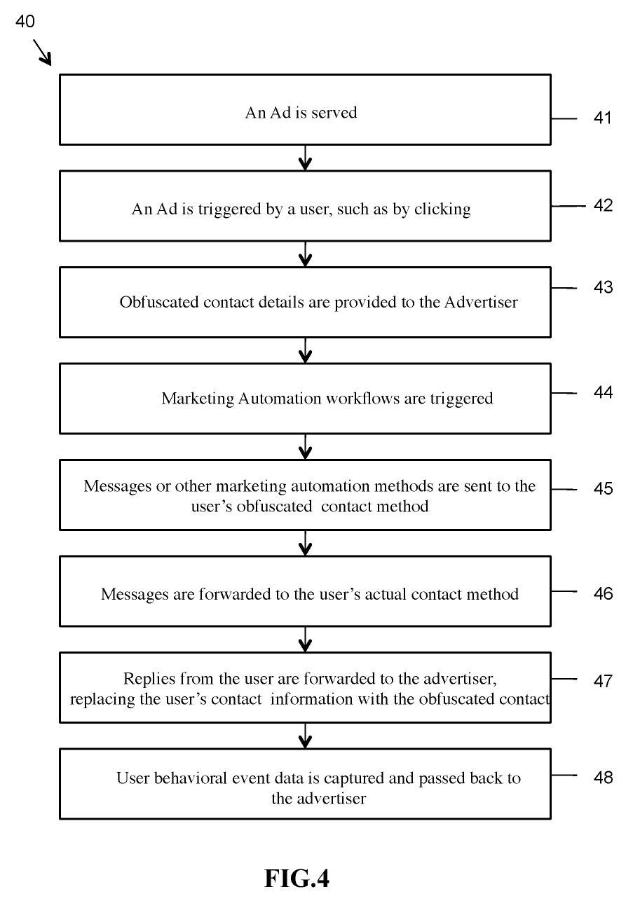

Referring to FIG. 4 shows a method (40) performed by the advertising system (17) for copyright content monetization, according to another embodiment of present invention. Step (41) describes serving an advertisement and step (42) describes triggering of the advertisement by a user, wherein triggering includes clicking or tapping operation on the advertisement. Step (43) describes providing to the advertiser the obfuscated contact details of the user. Step (44) describes triggering of marketing automation workflows. Step (45) describes transmission of messages or other marketing automation workflows from the advertiser to the obfuscated contact of user. Step (46) describes forwarding of the messages to the user's actual contact method. Step (47) describes forwarding of user replies to the advertiser. Step (48) describes about capturing of user behavioral event and sending the user behavioral event back to the advertiser.

In one embodiment of the invention, the automation actions or workflows are triggered by clicking or tapping the advertisement, by the user or ad-clicker, sending a text message to a mobile number or emailing to an email address listed in the advertisement, by voice command when interacting with audio-responsive technologies such as Alexa or Siri, by motion gesture when interacting with motion detecting device, by a thought gesture or thought keyword, when interacting with mind reading technologies, and by a change in state when interacting with a detection based system, such as a change in mood, body temperature, condition, etc.

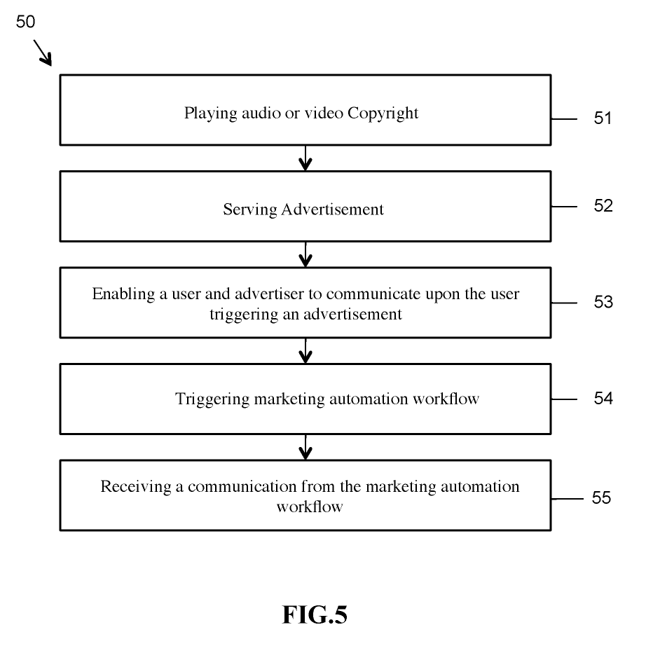

Referring to FIG. 5 shows a method (50) for increasing streaming rates of copyright to 20-40 times, by triggering advertising marketing automation workflows. Step (51) describes playing of audio or video copyright. Step (52) describes serving of an advertisement by advertising system. Step (53) describes enabling the advertiser to communicate with the user upon triggering the advertisement by the user. Step (54) describes triggering of marketing automation workflow of the advertiser. Step (55) describes reception of a communication from the marketing automation workflow of the advertiser by the user. By performing steps through (51)-(55) describes under the method (50), the rate of increase in copyright monetization is achieved.

With all these arrangements and functionalities of the present invention, it may be observed that the streaming rates can be increased by 20-40 times pre-optimization, and single-handedly resurrect the recorded music industry and the ability of musicians and other content creators to earn a living on recorded music and video.

It will finally be understood that the disclosed embodiments are presently preferred examples of how to make and use the claimed invention, and are intended to be explanatory rather than limiting of the scope of the invention as defined by the claims below. Reasonable variations and modifications of the illustrated examples in the foregoing written specification and drawings are possible without departing from the scope of the invention as defined in the claim below. It should further be understood that to the extent the term “invention” is used in the written specification, it is not to be construed as a limited term as to number of claimed or disclosed inventions or the scope of any such invention, but as a term which has long been conveniently and widely used to describe new and useful improvements in technology The scope of the invention supported by the above disclosure should accordingly be construed within the scope of what it teaches and suggests to those skilled in the art, and within the scope of any claims that the above disclosure supports. The scope of the invention is accordingly defined by the following claims.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A system for copyright content monetization, comprising:
a processing unit;
a storage unit connected to the processing unit, wherein the storage unit is adapted to store a plurality of executable modules;
a user interface, executed by the processing unit, streams an advertisement at least before playing a first copyright content or subsequent to end of playing the first copyright content;
a communication unit connected to the user interface, executed by the processing unit, adapted to:
set a communication link between a user and an advertiser, based on an input from the user, and
enable the advertiser to trigger marketing automation workflow based on at least one of input provided by the user or behavioral data of the user, wherein the behavioral data comprises a series of inputs provided by the user, in a time interval, that are stored in the storage unit;
an obfuscating unit, executed by the processing unit, adapted to obfuscate or mask, from the advertiser, information of user, wherein the information of the user comprises at least one of contact information or an email ID of the user;
an advertising unit, executed by the processing unit, adapted to create at least one of marketing automation workflow or connect third party marketing automation systems or workflows to the advertising system;
an alias messaging relay system, adapted to relay at least one message received, from the advertiser, by the user, wherein the alias messaging relay system is communicatively coupled with the advertising system, and wherein the message is received at the non-alias address of the user; and
an application programming interface (API), adapted to transmit or receive at least one message between the user and the advertiser, wherein the advertiser is adapted to link their account to a number of third party services through the API .

2. The system as claimed in claim 1, wherein the user interface includes at least one of a television, radio, virtual reality, or interactive media playing device.

3. The system as claimed in claim 1, wherein the advertising system provided with contact information of the user based on logging information of the user, into the advertising system, wherein the login information comprises at least one of the email ID, contact number, messaging handle, handle on a social network, virtual reality handle, or gaming handle.

4. The system as claimed in claim 1, wherein the advertising system provided with the contact information of the user based on collection and aggregation of the user data based on non-personally-identifiable methods, such as a IP address or hardware address of the user.

5. The system as claimed in claim 1, wherein the user is provided with a second copyright content on a first webpage, without being directed to a second web page based on a reception of an input from the user.

6. The system as claimed in claim 1, wherein the user is adapted to select the obfuscated information of the user provided to the advertiser.

7. The system as claimed in claim 1, wherein the information of the user includes at least one of a name, a contact number, an email ID or a physical mailing address.

8. The system as claimed in claim 1, wherein the advertisement is streamed before the beginning of a second copyright.

9. The system as claimed in claim 1, wherein the first copyright content comprises at least one of an audio data, visual data, or audio-visual data.

10. A method for copyright content monetization, comprising:
streaming an advertisement at least before playing a first copyright content or subsequent to end of playing the first copyright content;
communicating with an advertiser based on an input from the user;
triggering marketing automation workflow based on at least one of the input provided by the user or behavioral data of the user;
obfuscating information of user from the advertiser, wherein the information of the user comprises at least one of contact information or an email ID of the user;
sending obfuscated contact information to the advertiser;
creating at least one of marketing automation workflow or connecting third party marketing automation systems or workflows to an advertising system;
relaying at least one message received, from the advertiser, by the user, wherein the alias messaging relay system is communicatively coupled with the advertising system; and wherein the message is received at the non-alias address of the user; and
transmitting or receiving at least one message between the user and the advertiser.

11. The method as claimed in claim 10, wherein the triggering comprises clicking or tapping operation on the advertisement.

12. The method as claimed in claim 10, wherein the triggering comprises sending a text message to the contact number listed in the advertisement.

13. The method as claimed in claim 10, wherein the user behavior data includes communicative events or non-communicative events of user, wherein the events include opening, viewing, clicking, sharing, forwarding a message, online purchasing, engaging with or completing certain activity, and clicking or sharing links.

14. The method as claimed in claim 10, wherein the message is transmitted or received based on an application program interface (API) or a communication method.

15. A method for copyright content monetization via a text message, comprising:
receiving a text message that includes a sponsored advertisement link of an advertisement;
executing advertisement link or replying to the text message with a text keyword based on an input provided by a user;
obfuscating information of user from the advertiser, wherein the information of the user comprises at least one of contact information or an email ID of the user; and
sending obfuscated contact information to the advertiser;
creating at least one of marketing automation workflow or connecting third party marketing automation systems or workflows to an advertising system;
relaying at least one message received, from the advertiser, by the user, wherein the alias messaging relay system is communicatively coupled with the advertising system; and wherein the message is received at the non-alias address of the user; and
receiving, by the user, a predefined marketing automation workflow of the advertiser as one or more text messages from the advertiser;
transmitting or receiving at least one message between the user and the advertiser.

16. The method as claimed in claim 15, wherein the message is transmitted or received by using an application program interface (API) or communication method.
